(19) United States
(12) Patent Application Publication
(10) Pub. No.: US 2026/0181368 A1
(43) Pub. Date: Jun. 25, 2026

(54) COMMUNICATION APPARATUS AND COMMUNICATION METHOD FOR PEER-TO-PEER SENSING

(71) Applicant: Panasonic Intellectual Property Corporation of America, Torrance, CA (US)

(72) Inventors: Rajat PUSHKARNA, Singapore (SG); Yoshio URABE, Nara (JP); Hiroyuki MOTOZUKA, Kanagawa (JP)

(21) Appl. No.: 19/121,387

(22) PCT Filed: Oct. 5, 2023
(86) PCT No.: PCT/SG2023/050677

§ 371 Date: Apr. 15, 2025

(30) Foreign Application Priority Data
Oct. 19, 2022 (SG) 10202251428D

(51) Int. Cl. H04W 8/00; H04L 67/104

(52) U.S. Cl. CPC H04W 8/005; H04L 67/104

(57) ABSTRACT

Communication devices and methods for peer-to-peer sensing are provided. One exemplary embodiment provides a first communication apparatus comprising: circuitry, which in operation, generates a request frame for a second communication apparatus for sensing measurement, wherein both the first and the second communication apparatuses are non-AP STAs; and a transmitter, which in operation, transmits the request frame to the second communication apparatus.

### TECHNICAL FIELD

The present disclosure generally relates to communication methods and apparatuses, and more particularly relates to methods and apparatuses for peer-to-peer (P2P) sensing.

### BACKGROUND

Wireless local area network (WLAN) Sensing mechanisms discussed in IEEE 802.11bf Task Group (TGbf) are considering scenarios where the access point (AP) is WLAN Sensing capable (IEEE 802.11bf capable, hereinafter referred to as “11bf capable”). However, in practical scenarios, it is possible that the AP is not usually replaced or upgraded as early as a station (STA). For example, people may change their laptops, handphones much earlier than they change their home AP. Considering the above, it is possible to see 11bf capable non-AP STAs much earlier than 11bf capable APs in the deployment. It is therefore important to consider scenarios where peer-to-peer sensing is performed between two non-AP STAs.

However, there is still limited discussion on communication apparatuses and methods for peer-to-peer sensing.

There is thus a need for communication apparatuses and methods that can solve the above-mentioned issues. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for peer-to-peer sensing.

According to an aspect of the present disclosure, there is provided a first communication apparatus comprising: circuitry, which in operation, generates a request frame for a second communication apparatus for sensing measurement, wherein both the first and the second communication apparatuses are non-AP STAs; and a transmitter, which in operation, transmits the request frame to the second communication apparatus.

According to another aspect of the present disclosure, there is provided a second communication apparatus comprising: a receiver, which in operation, receives a request frame from a first communication apparatus, wherein both the first and the second communication apparatuses are non-AP STAs; and a transmitter, which in operation, transmits a response frame to the first communication apparatus for performing P2P sensing measurement.

According to another aspect of the present disclosure, there is provided a communication method comprising: generating, at a first communication apparatus, a request frame for a second communication apparatus for sensing measurement, wherein both the first and the second communication apparatuses are non-AP STAs; and transmitting the request frame to the second communication apparatus.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts an example illustration of a peer-to-peer sensing scenario.

FIG. 2A depicts an example illustration of a peer-to-peer sensing scenario when 2 non-AP STAs are in the same basic service set (BSS).

FIG. 2B depicts an example illustration of a peer-to-peer sensing scenario when 2 non-AP STAs are in different BSS.

FIG. 2C depicts an example illustration of a peer-to-peer sensing scenario when a responder is an unassociated STA.

FIG. 3 depicts an example illustration of a peer-to-peer sensing scenario where a Tunneled Direct Link Setup (TDLS) link is established between the two non-AP responders within the same BSS.

FIG. 4 depicts an example illustration of signaling details for the peer-to-peer sensing scenario illustrated in FIG. 3.

FIG. 5A depicts an example illustration of a peer-to-peer sensing scenario with no AP involved according to various embodiments of the present disclosure.

FIG. 5B depicts an example illustration of a peer-to-peer sensing scenario with a peer STA that is an overlapping BSS (OBSS) or an unassociated STA, according to various embodiments of the present disclosure.

FIG. 5C depicts an example illustration of a peer-to-peer sensing scenario with a peer STA within a same BSS according to various embodiments of the present disclosure.

FIG. 6 depicts an illustration of a peer-to-peer sensing measurement procedure between two non-AP STAs via Wi-Fi Direct link according to an embodiment of the present disclosure.

FIG. 7 depicts a flowchart illustrating a STA behaviour during Group Owner (GO) assignment according to an embodiment of the present disclosure.

FIG. 8 depicts a flowchart illustrating a STA behaviour as a GO in a Wi-Fi direct group according to an embodiment of the present disclosure.

FIG. 9 depicts a flowchart illustrating a GO behaviour as a sensing initiator according to an embodiment of the present disclosure.

FIG. 10 depicts an illustration of a non-trigger-based (non-TB) sensing measurement instance with a GO as a sensing initiator according to an embodiment of the present disclosure.

FIG. 11 depicts an illustration of a trigger-based (TB) sensing measurement process with a GO as a sensing initiator according to an embodiment of the present disclosure.

FIG. 12 depicts an illustration of exemplary sensing measurement setup request and response frames according to an embodiment of the present disclosure.

FIG. 13A depicts an illustration of a P2P Sensing Parameters element according to an embodiment of the present disclosure.

FIG. 13B depicts an illustration of a variation of indicating P2P sensing parameters using Sensing Element according to an embodiment of the present disclosure.

FIG. 14 shows a flowchart illustrating steps for report aging calculation according to an embodiment of the present disclosure.

FIG. 15 depicts an illustration of a null data packet announcement (NDPA) frame format according to an embodiment of the present disclosure.

FIG. 16 depicts a one-to-many sensing measurement procedure between a GO and two other STAs according to an embodiment of the present disclosure.

FIG. 17 depicts an illustration of a NDPA frame format to be used for a one-to-many sensing measurement case according to an embodiment of the present disclosure.

FIG. 18 depicts a sensing measurement procedure between a GO and an unassociated STA according to various embodiments of the present disclosure.

FIG. 19 depicts an example illustration of a peer-to-peer sensing between a non-AP STA and an unassociated STA according to various embodiments of the present disclosure.

FIG. 20 depicts an unassociated STA discovery and unassociated STA identifier (UID) assignment procedure according to an embodiment of the present disclosure.

FIG. 21 depicts an illustration of an Action field format for a Sensing Measurement Setup Query frame according to an embodiment of the present disclosure.

FIG. 22 depicts a variation of the unassociated STA discovery and UID assignment process according to an embodiment of the present disclosure.

FIG. 23 depicts an example illustration of a peer-to-peer sensing process between STAs in an OBSS according to various embodiments of the present disclosure.

FIG. 24 depicts a peer-to-peer sensing measurement procedure with an OBSS STA according to an embodiment of the present disclosure.

FIG. 25 depicts an example configuration of a STA suitable for sensing and communication in accordance with various embodiments of the present disclosure.

FIG. 26 shows a flow diagram illustrating a method for peer-to-peer sensing according to various embodiments of the present disclosure.

FIG. 27 shows a schematic, partially sectioned view of a STA that can be implemented for peer-to-peer sensing in accordance with various embodiments of the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. There is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for peer-to-peer sensing.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a station may be a laptop, a desktop personal computer (PC), a personal digital assistant (PDA), either an access point or not (e.g., either an AP STA or a non-AP STA), or a Wi-Fi phone in a wireless local area network (WLAN) environment. The station may be fixed or mobile. In the WLAN environment, the terms “STA”, “non-AP STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at different occasions, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

Wi-Fi Certified Wi-Fi Direct® enables Wi-Fi devices to connect directly to each other, making it simple and convenient to print, share, sync, play games, and display content to another device. Wi-Fi Direct devices connect to one another without joining a traditional home, office, or public network. A group owner (GO) in Wi-Fi Direct protocol acts similar to an AP. Once a STA becomes the group owner, it can assign IDs to the STAs and can coordinate like an AP with other STAs in the group. Once a STA becomes the group owner, it can assign IDs to the STAs and can coordinate like an AP with other STAs in the group.

The current sensing protocol does not support sensing between two non-AP STAs. The present disclosure thus provides solutions for sensing between two non-AP STAs. It is possible in some scenarios that the AP may not be WLAN Sensing (11bf) capable.

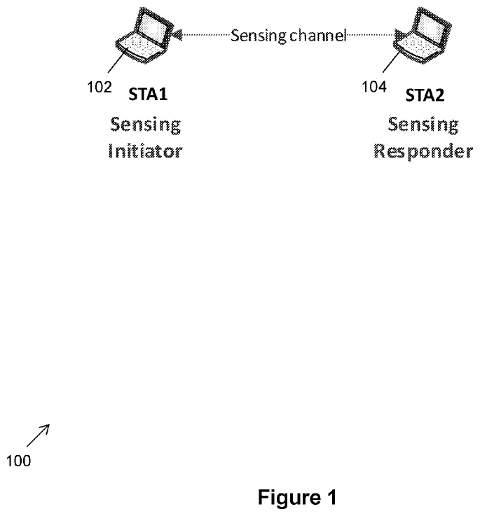

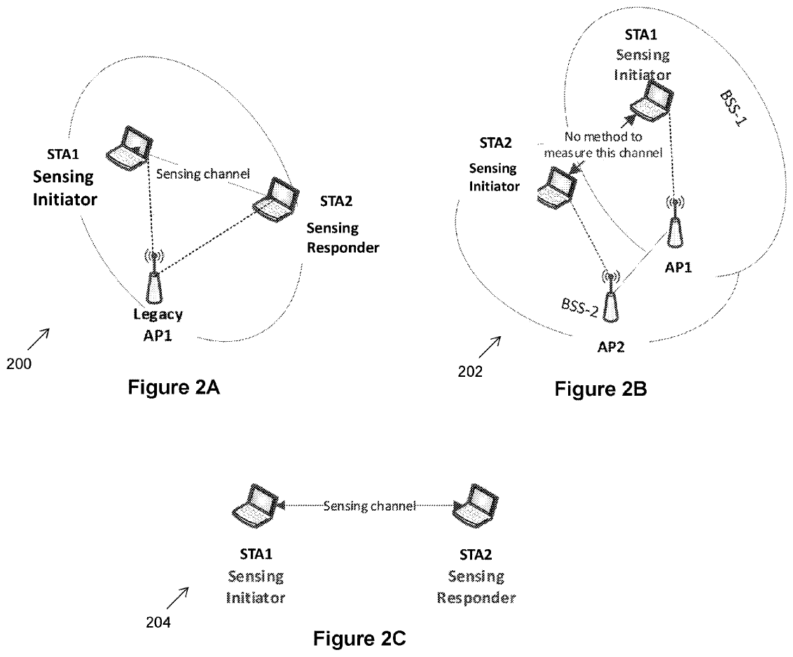

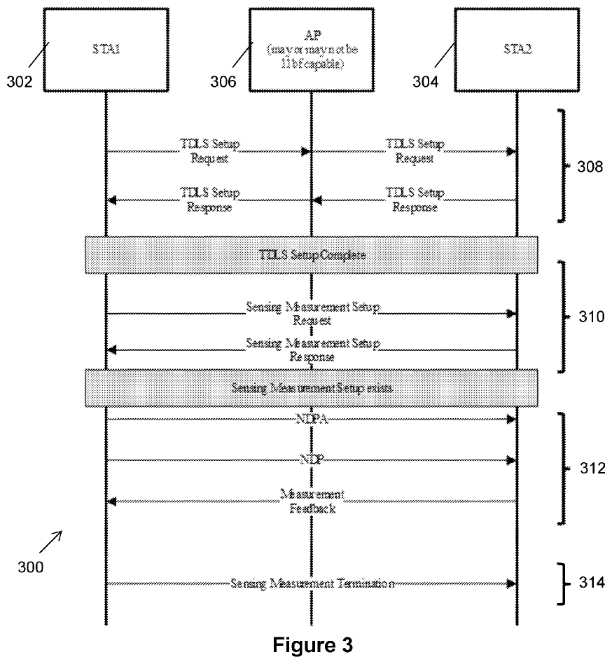

To support sensing between two non-AP STAs in 802.11bf, a scenario as shown in illustration 100 of FIG. 1 can be considered. In illustration 100, sensing responder 104 may belong to the same BSS as sensing initiator 102 (i.e. sensing initiator 102 and sensing responder 104 are associated with the same AP) or to an OBSS (i.e. each of sensing initiator 102 and sensing responder 104 is associated with different AP), or may not be associated to an AP. Based on this scenario, there are two possible cases to consider: a case when both the non-AP STAs are in same BSS as shown in illustration 200 of FIG. 2A, and another case when one of the non-AP STA is an OBSS STA as shown in illustration 202 of FIG. 2B. Further, another case where the P2P sensing capable STA is an unassociated STA as shown in illustration 204 of FIG. 2C.

FIG. 3 depicts an example illustration of a peer-to-peer sensing scenario according to an embodiment of the present disclosure. In the illustration 300 of FIG. 3, a Tunneled Direct Link Setup (TDLS) link is established between two non-AP STAs, that is STA1 302 and STA2 304, within same BSS. In the illustration 300, there is an AP 306 which may or may not be 11bf capable. TDLS is characterized by encapsulating setup frames in Data frames, which allows them to be transmitted through an AP transparently. In an example, STA1 302 initiates a TDLS Setup for other applications, but if the peer STA (e.g., STA2 304) is 11bf capable, then sensing may also be performed over TDLS link. As shown in FIG. 3, during a TDLS setup phase 308, sensing capabilities are exchanged. For example, TDLS Discovery frames or TDLS Setup Request/Response frames carry P2P sensing capability field which may be used to inform STA1 302 that STA2 304 has the peer-to-peer sensing capability. In the TDLS setup phase 308, a TDLS setup request is transmitted from STA 302 via AP 306 to STA2 304; and a TDLS setup response is transmitted from STA2 304 via AP 306 to STA1 302, to complete the TDLS setup. After TDLS setup is completed, sensing measurement setup phase 310 is performed over the direct link between STA1 302 and STA2 304 to perform peer-to-peer sensing measurement. In particular, STA1 302 may send a sensing measurement setup request to STA2 304, and then STA2 304 may send a sensing measurement setup response to STA1 302 to complete the sensing measurement setup. After sensing measurement setup is completed, a non-trigger-based (non-TB) sensing measurement instance may be used to perform channel measurements during a sensing measurement phase 312. A non-trigger-based (non-TB) sensing measurement instance may include, for example, transmission of an NDPA frame and a null data PPDU (NDP), where PPDU stands for physical layer protocol data unit, and reception of a Measurement Report Frame. Next, in a termination phase 314, a sensing setup termination may be performed by STA1 302 to terminate sensing measurement between the STAs 302 and 304. If there are more than 3 STAs, TDLS setup is required for each STA pair.

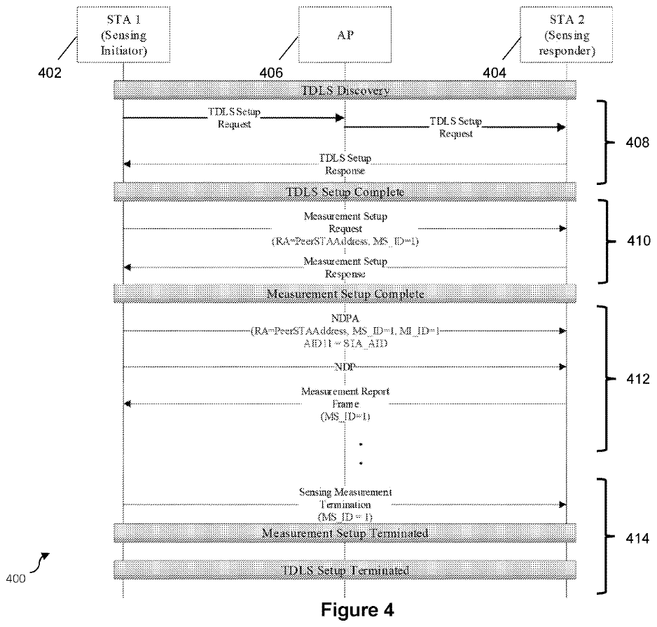

FIG. 4 depicts an example illustration 400 of signaling details for the peer-to-peer sensing scenario of illustration 300 in FIG. 3. For example, in TDLS setup phase 408, association identifiers (AIDs) are exchanged during the TDLS Setup Request/Response frame exchange between STA1 402 and STA2 404. STA1 402 knows STA2 404 AID by receiving the TDLS Setup Response including STA2's 404 AID. During sensing measurement setup phase 410, Receiver Address (RA) is set to the media access control (MAC) address of STA2 404, MS_ID is set to 1, for example, and MI_ID is set to 1, for example, in the measurement setup request frame transmitted from STA1 402 to STA2 404; wherein the MS_IS and MI_ID are the measurement setup ID and the Measurement Instance ID. During sensing measurement phase 412, Receiver Address (RA) is set to the MAC address of STA2 404, MS_ID is set to 1, MI_ID is set to 1 and AID11 is set to the AID of STA2 404 in the NDPA frame transmitted from STA1 402 to STA2 404. The MS_ID is set to 1 in the measurement report frame transmitted from STA2 404 to STA1 402. In a termination phase 414, the MS_ID is set to 1 in a sensing measurement termination frame transmitted from STA1 402 to STA2 404 to indicate that the sensing measurement report belongs to measurement setup ID set to 1.

Current draft 11bf protocols make use of an AP 406 either as a sensing responder (e.g., for non-TB sensing case) or a sensing initiator (e.g., for TB sensing case) to perform sensing. As an effect of the sensing measurement process in illustrations 300 and 400, an 11bf non-AP STA can perform sensing with another non-AP STA without the involvement of an AP 406. However, AP 406 is still required for initial setup of TDLS link as shown in illustrations 300 and 400.

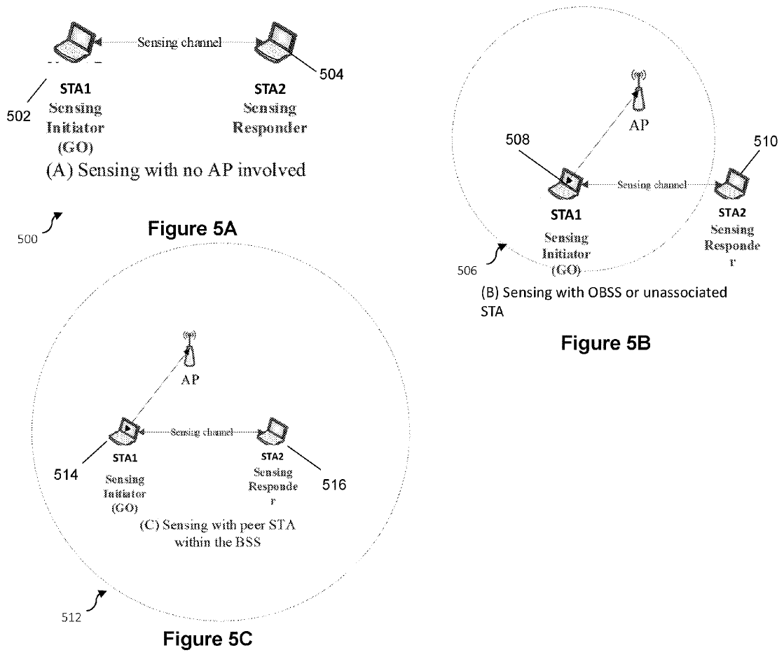

Thus, further to the embodiments as shown in illustrations 300 and 400, the present disclosure provides methods to enable peer-to-peer sensing between two non-AP STAs either in a BSS, OBSS, or outside a BSS scenario. A mechanism to enable P2P sensing independently between 2 peer STAs is discussed (e.g., as shown in illustration 500 of FIG. 5A, 506 of FIG. 5B, 512 of FIG. 5C), wherein an 11bf capable STA1 502, 508, 514 can act as a Group Owner (GO) and forms a Wi-Fi Direct group with 11bf capable STAs (e.g., STA2 504, 510, 516) within or outside the BSS to perform sensing. In an example scenario (e.g., FIG. 5A), one of unassociated STAs becomes a Group Owner (STA1 502) and performs sensing with a peer STA (STA2 504) over a peer-to-peer communication link (e.g., Wi-Fi direct link). In another example scenario (e.g. FIG. 5B), a non-AP STA (STA1 508) that belongs to a BSS may become a Group Owner and perform sensing with a peer STA (STA2 510) that is an OBSS or an unassociated STA over a peer-to-peer communication link (e.g., Wi-Fi direct link). In another example scenario (e.g. FIG. 5C), a non-AP STA (STA1 514) that belongs to a BSS may become a Group Owner and perform sensing with a peer non-AP STA (STA2 516) that belongs to the BSS over a peer-to-peer communication link (e.g., Wi-Fi direct link).

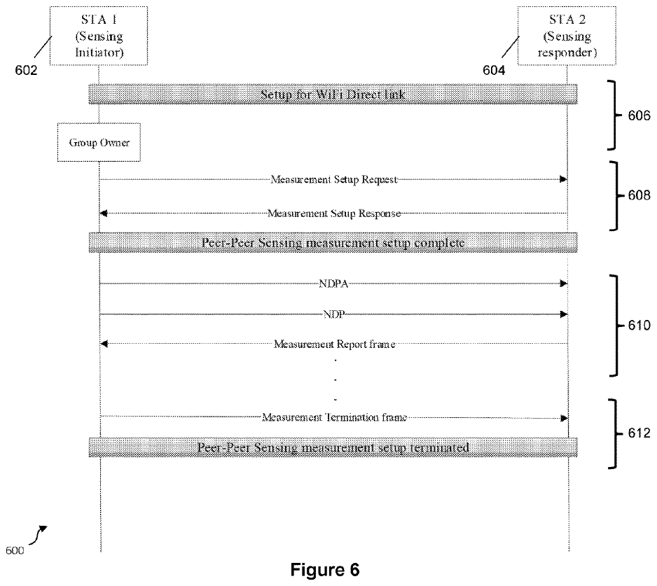

FIG. 6 depicts an illustration 600 of a peer-to-peer sensing measurement procedure between two STAs (e.g., STA1 602 and STA2 604) via Wi-Fi Direct link according to an embodiment of the present disclosure. In a Wi-Fi Direct link setup phase 606, STA1 602 and STA2 604 perform setup for Wi-Fi Direct link. During the setup, STA1 602 may be assigned as the GO. STA1 602 being a GO for the Wi-Fi Direct link acts as an AP during and after the setup e.g., by transmitting beacon, performing authentication, association, and other similar procedures. After the Wi-Fi Direct link is established, the STAs 602 and 604 perform a peer-to-peer sensing measurement setup procedure 608 which may include sensing session setup or sensing measurement setup. In the sensing measurement procedure 608, STA 1 602 may transmit a Measurement Setup Request frame, for which the format is reuse of the frame for AP-STA sensing setup, with setting the receiver address (RA) field to P2P interface address of STA 2 (e.g. MAC address of STA2), and STA 2 608 may transmit a Measurement Setup Response frame, for which the format is reuse of the frame for AP-STA sensing setup, with setting the receiver address (RA) field to P2P interface address of STA 1 (e.g. MAC address of STA 1). STA1 602 being a GO for the Wi-Fi Direct link behaves as an initiator for this setup. After the setup is completed, non-TB sensing measurements (e.g., sensing measurement phase 610) may be performed between the STAs 602 and 604. After sensing measurements are completed, the STAs may perform sensing termination in a termination phase 612.

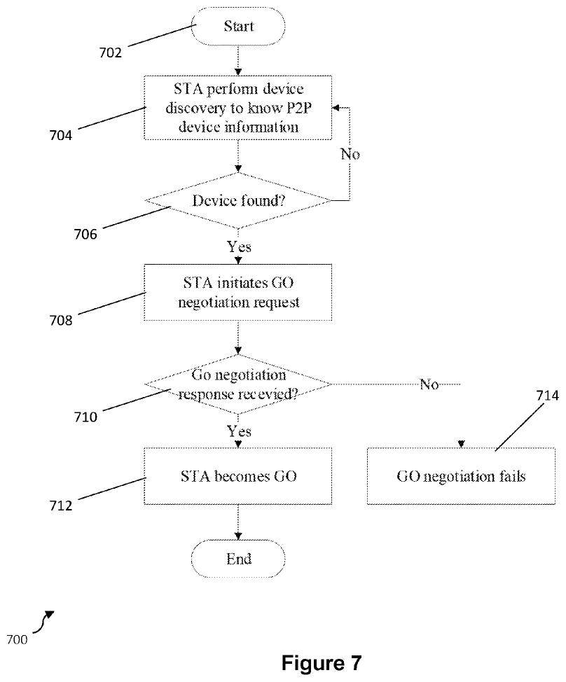

FIG. 7 depicts a flowchart 700 illustrating a STA behaviour during GO assignment according to an embodiment of the present disclosure. This procedure takes place during setup for Wi-Fi Direct, and shows how a STA becomes a GO. The process begins at step 702. In a next step 704, the STA performs device discovery to obtain P2P device information. In the step 704, the STA may transmit and/or receive a Probe Request frame that includes an Information Element (IE) that includes capability information and parameters to perform peer-to-peer (P2P) communication and capability information to indicate support of sensing functions. For example, the Information Element for P2P communication may include the capability information for sensing function as an attribute. Alternatively or additionally, the Probe Request frame may include capability information for sensing function in addition to the Information Element for P2P communication. In a step 706, it is determined whether a device is found during the device discovery. If a device is not found, the process returns to step 704. Otherwise, the process proceeds to step 708 where the STA initiates a GO negotiation request. In a step 710, it is determined whether the GO negotiation request is received. If it is determined that the GO negotiation request is not received, the process proceeds to step 714 such that the GO negotiation is deemed to have failed, and the process ends. Otherwise, the process proceeds to step 712 where the STA becomes the GO, and the process ends.

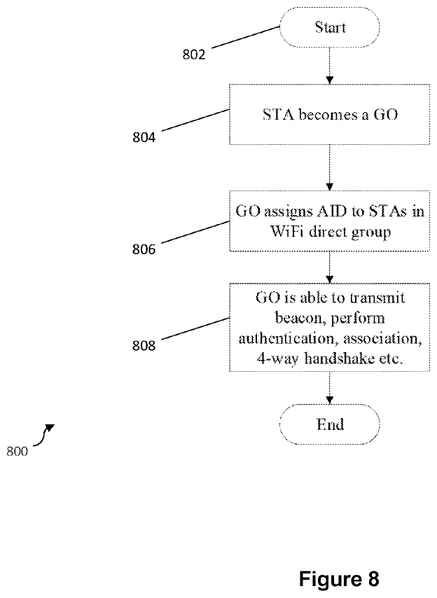

FIG. 8 depicts a flowchart 800 illustrating a STA behaviour as a GO in a Wi-Fi direct group according to an embodiment of the present disclosure. The process begins at step 802. In a step 804, an STA becomes a GO of a Wi-Fi Direct group. In a step 806, the GO assigns AID(s) to other STA(s) in the Wi-Fi Direct group. The AID(s) are assigned to the STAs which are part of Wi-Fi Direct group by the GO during Wi-Fi Direct group setup and may be done using the association request/response frames. For example, the GO owner may assign the AID to the peer STAs which are part of Wi-Fi Direct during the association process. The association request frame may include an Information Element that includes information related to P2P communication so as to specify that the exchange of the association request/response frames is part of setup procedure of P2P communication (e.g. Wi-Fi direct link). In a step 808, the GO is able to transmit beacon, perform authentication, association, 4-way handshake, and other similar procedures, and the process ends.

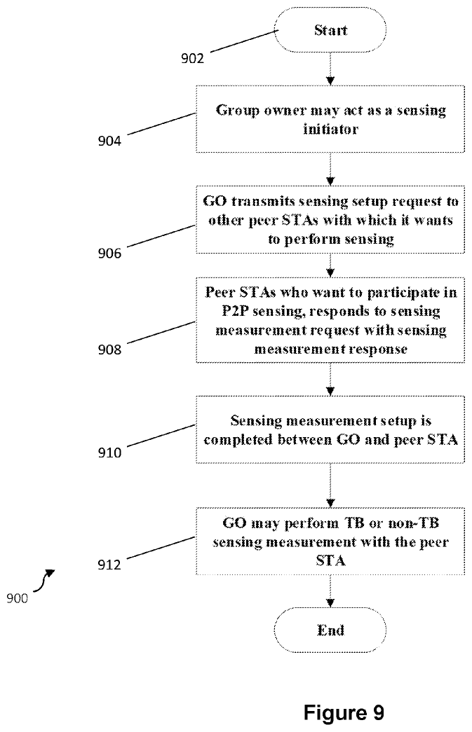

FIG. 9 depicts a flowchart 900 illustrating a GO behaviour as a sensing initiator according to an embodiment of the present disclosure. The process begins at step 902. In a step 904, a GO may act as a sensing initiator. In a step 906, the GO transmits sensing setup request(s) to other peer STA(s) with which it wants to perform sensing. In a step 908, peer STA(s) that wish to participate in P2P sensing responds to the sensing measurement request with a sensing measurement response. In a step 910, sensing measurement setup is completed between the GO and the peer STA(s). In a step 912, the GO may perform TB or non-TB sensing measurement with the peer STA(s), and the process ends.

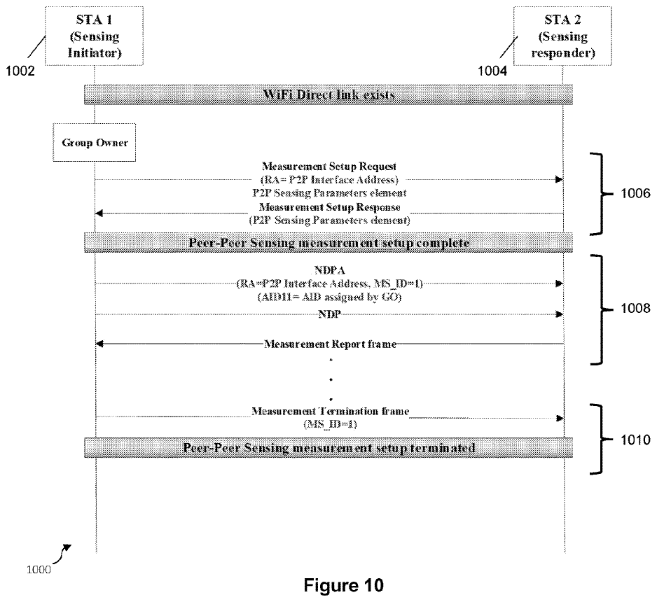

FIG. 10 depicts an illustration 1000 of a non-trigger-based (non-TB) sensing measurement procedure with a non-AP STA GO as a sensing initiator according to an embodiment of the present disclosure. The STA1 1002 which is a Wi-Fi Direct GO may be a sensing initiator. The Wi-Fi Direct GO is a non-AP STA and performs non-TB sensing measurement instance in contrast to state of the art where non-TB sensing measurement can only be performed between an AP and a non-AP STA. As a sensing initiator, the GO may perform sensing related frame exchanges to perform P2P sensing. In a sensing measurement setup phase 1006, the GO (e.g., sensing initiator STA1 1002) performs sensing measurement setup with peer STA STA2 1004. For example, RA is set to P2P Interface Address in a sensing measurement setup request frame transmitted from STA1 1002 to STA2 1004. The setup request frame may further comprise a P2P Sensing Parameters element. Further, a P2P Sensing Parameters element may also be present in a sensing measurement response frame transmitted from STA2 1004 to STA1 1002. During sensing measurement phase 1008, RA is set to the P2P Interface Address, MS_ID is set to 1, and AID11 is set to the AID assigned by the GO to STA2 1004 in a NDPA frame transmitted from STA1 1002 to STA2 1004. The P2P interface address is the MAC address of the peer STA participating in the Wi-Fi Direct group e.g., the MAC address of STA2 1004. Further, in a termination phase 1010, the MS_ID is set to 1 to indicate that measurement setup with measurement setup ID set to 1 is to be terminated. The termination frame is transmitted from STA1 1002 to STA2 1004 to terminate the P2P sensing measurement.

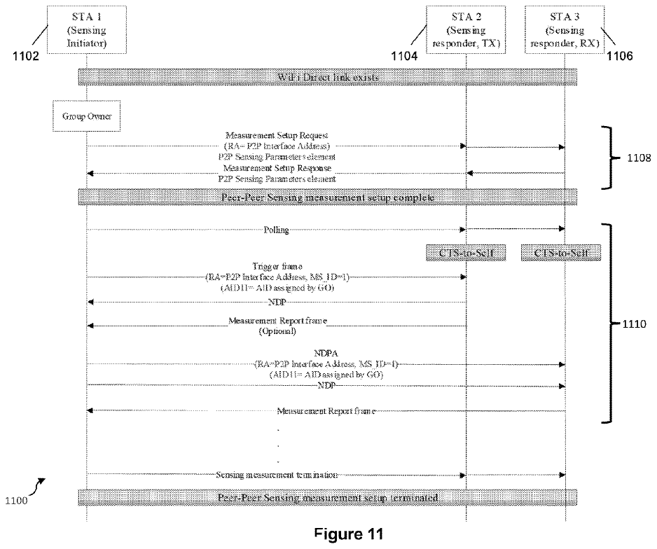

FIG. 11 depicts an illustration of a TB sensing measurement process with a non-AP STA GO as a sensing initiator according to an embodiment of the present disclosure. STA1 1102 is the GO and sensing initiator. Based on the capabilities of the responders which are STA2 1104 and STA3 1106, the STA1 1102 being a GO may initiate a TB sensing in the case of STA2 1104 and STA3 1106 being High Efficiency/Extra High Throughput/Extra High Throughput+ (HE/EHT/EHT+) STAs (e.g., EHT+ being any amendment after EHT). The GO, during a TB sensing measurement procedure may assign resources to the peer STA, may schedule sensing measurement etc., compared to non-TB sensing measurement instance. In a sensing measurement setup phase 1108, the GO (e.g., sensing initiator STA1 1102) performs measurement setup with peer STAs STA2 1104 and STA3 1106. For example, RA is set to MAC address of STA2 1104 in a sensing measurement setup request frame transmitted from STA1 1102 to STA2 1104 and set to MAC address of STA3 1106 in a sensing measurement setup request frame transmitted from STA1 1102 to STA3 1106. The setup request frames may further comprise a P2P Sensing Parameters element. Further, a P2P Sensing Parameters element may also be present in sensing measurement response frames transmitted from STA2 1104 and STA3 1106 to STA1 1102. During sensing measurement phase 1110, RA is set to the P2P Interface Address (e.g., MAC address of STA2 1104), MS_ID is set to 1, and AID11 is set to the AID assigned by the GO to STA2 1104 in a trigger frame transmitted from STA1 1102 to STA2 1104. Similarly, RA is set to the P2P Interface Address (e.g., MAC address of STA3 1106), MS_ID is set to 1, and AID11 is set to the AID assigned by the GO to STA2 1104 in a NDPA frame transmitted from STA1 1102 to STA3 1106. During the sensing measurement phase, a STA which is a sensing responder and is acting as a sensing transmitter may optionally transmit sensing measurement report frame to the STA transmitting the Trigger frame to solicit NDP. For example, STA2 1104 which is a sensing responder acting as a sensing transmitter may optionally transmit sensing measurement report frame to STA1 1102. A STA which is a sensing responder and is acting as a sensing receiver shall transmit sensing measurement report frame to the STA which is transmitting the NDPA and NDP to the sensing responder. For example, STA3 1106 which is a sensing responder acting as a sensing receiver shall transmit the sensing measurement report frame upon reception of NDPA and NDP from STA1 1102.

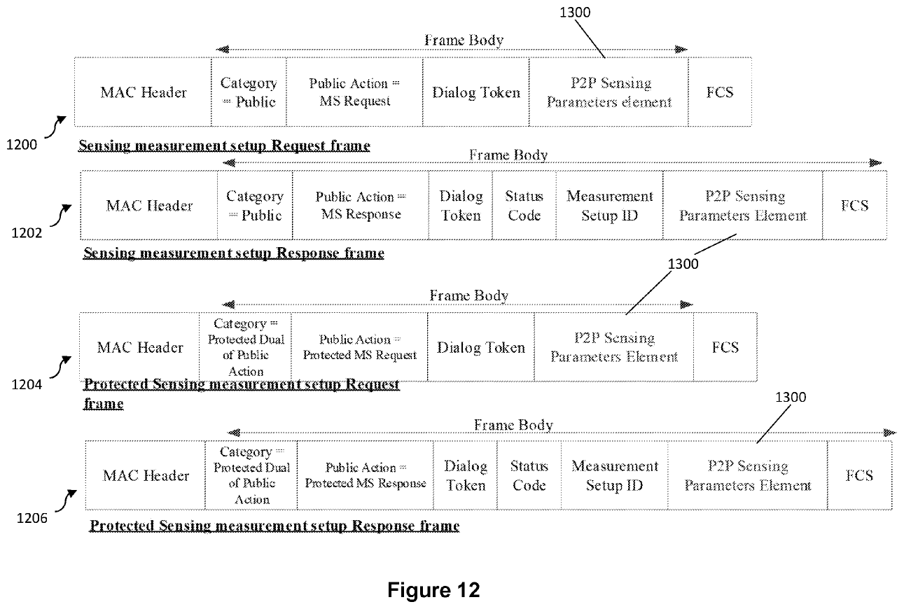

FIG. 12 depicts an illustration of exemplary sensing measurement setup request and response frames with P2P Sensing Parameters element according to an embodiment of the present disclosure. The sensing measurement setup request and response frames in FIG. 12 are defined in 11bf for AP-STA sensing. These frames may be reused for P2P sensing (e.g., STA1 and STA2 as shown in, for example, illustration 1100 may transmit these frames during setup). For example, sensing measurement setup request frame 1200, sensing measurement setup response frame 1202, protected sensing measurement setup request frame 1204 and protected sensing measurement setup request frame 1206 may comprise a new P2P Sensing Parameters element 1300 which is present instead of, or in addition to the element for AP-STA sensing (e.g., Sensing Measurement Parameters element) if the STA is P2P sensing capable STA. The P2P Sensing Parameters element 1300 is configured for peer-to-peer sensing as shown in the embodiments of the present disclosure (e.g., the sensing measurement process as shown in illustration 1100 and the other examples discussed herein), because it carries the capabilities and information relating to a peer STA to perform P2P Sensing.

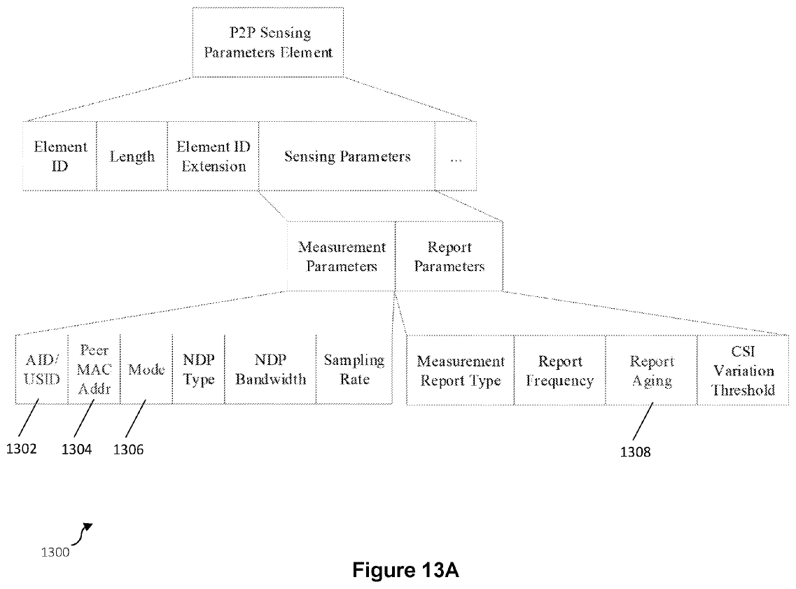

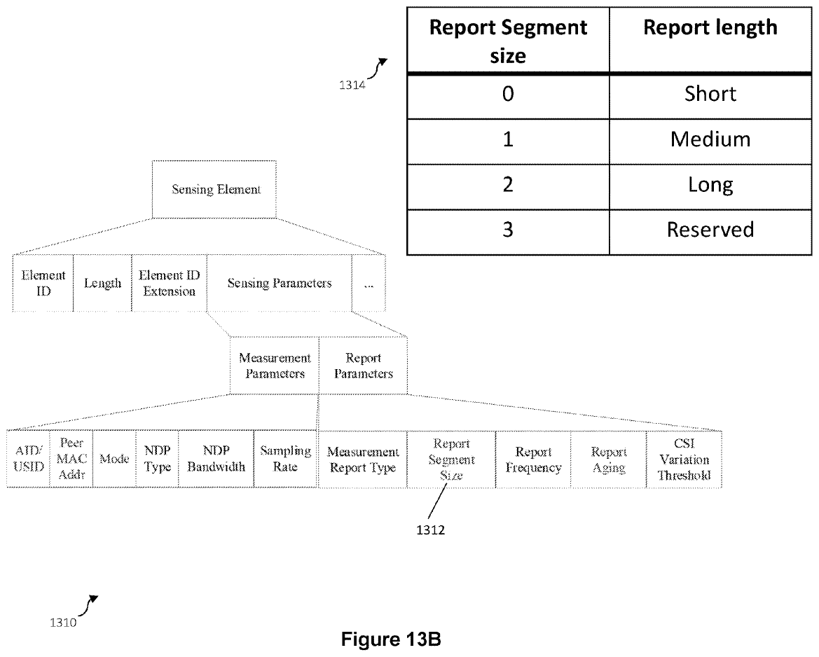

FIG. 13A depicts an illustration of a P2P Sensing Parameters element 1300 according to an embodiment of the present disclosure. The P2P Sensing Parameters element 1300 may comprise: an AID/USID field 1302 which carries the AID or USID of a peer STA; a Peer MAC Address field 1304 that carries the MAC address of the peer STA; a Mode field which is a 1-bit field that is set to 1 by a sensing responder if the responder(s) are capable of receiving a Sensing Trigger frame, and reserved if otherwise; and a Report Aging field that indicates a unit of time after which the measurement report is not usable. The purpose of report aging is for a responder to understand if it should transmit a measurement report or not because, in a case of delayed reporting, it is possible that a measurement report is delayed beyond a specific time period after which it may not be usable by the application. This mechanism may advantageously help in saving airtime. Report aging should be assigned in time units (TUs). For example, if the Report Aging field indicates a value of 2, it means that a measurement report which is received at the initiator after 2 TUs will be outdated and thus not usable.

P2P Sensing Parameters element may be a variant of Information Element for P2P communication. Alternatively, the sensing measurement setup request and/or response frames may include a Sensing Measurement Parameters element with extension for P2P sensing (e.g. additional fields for P2P sensing). The extended sensing measurement setup request and/or response frames may include P2P indication field that indicates the sensing is performed over P2P link, a Mode field 1306, and/or a Report Aging field 1308.

FIG. 13B depicts an illustration of a Sensing element 1310 which can be reused for the purpose of indicating P2P sensing parameters. A Report Segment Size field 1312 is introduced to indicate the measurement report size. The Report Segment Size field 1312 is 2-bits and 4 values are configured; wherein 0 corresponds to short report size which may be equal to 3750 octets, 1 corresponds to medium report size which may be equal to 7900 octets and 2 corresponds to long report size which maybe equal to 11350 octets. The value 3 is reserved. Table 1314 in FIG. 13B illustrates the configuration and meaning of the Report Segment Size field 1312. Alternatively, segment size may be implicitly derived from an AP's sensing by proxy (SBP) capability. For example, if the AP supports SBP, segment size=smallest size (e.g., 3750 octets); otherwise segment size=largest possible size (e.g., 11350 octets).

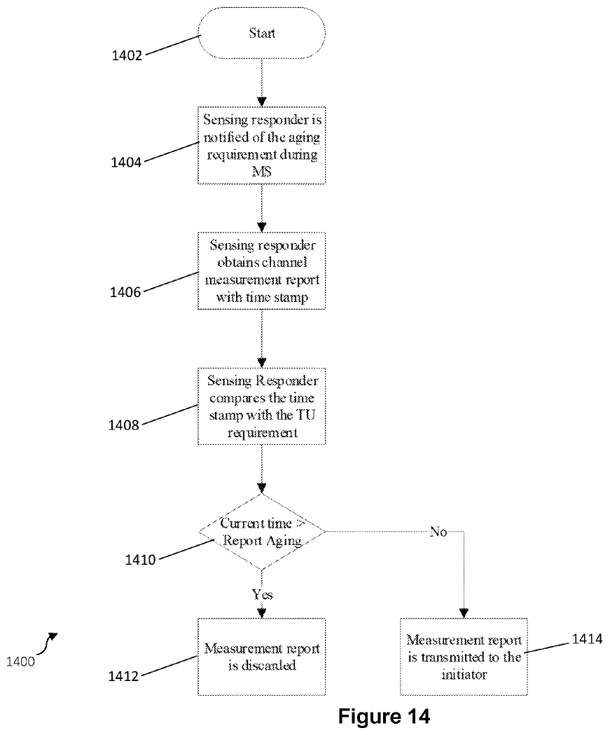

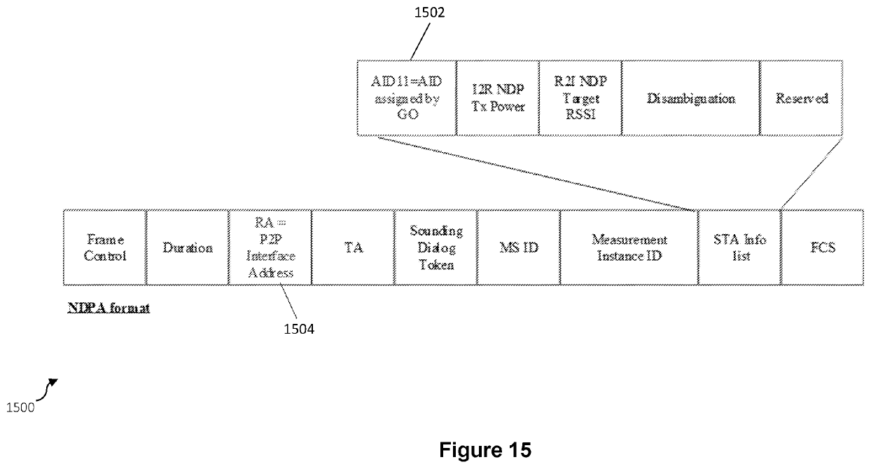

FIG. 14 shows a flowchart 1400 illustrating a process for report aging calculation according to an embodiment of the present disclosure. The process begins at step 1402. In step 1404, a sensing responder is notified of the aging requirement (e.g., TU requirement) during measurement sensing setup (e.g., via a value indicated in a Report Aging field of a P2P Sensing Parameters element in a sensing measurement setup request frame received by the sensing responder from a sensing initiator). In step 1406, the sensing responder obtains a channel measurement report with time stamp. In step 1408, the sensing responder compares the time stamp with the TU requirement. In step 1410, it is determined if a current time is later than a time calculated by adding the TU requirement with the time stamp. If it is determined to be later, the process proceeds to step 1412 where the measurement report is discarded. Otherwise, the process proceeds to step 1414 where the measurement report is transmitted to the sensing initiator.

FIG. 15 depicts an illustration of a null data packet announcement (NDPA) frame 1500 that is configured for sensing measurement according to the various embodiments of the present disclosure. The NDPA frame 1500 may comprise an AID11 field 1502 that is set to an AID assigned by a GO to a sensing responder. The NDPA frame 1500 may also comprise a RA field 1504 that is set to P2P Interface Address of the sensing responder that receives the NDPA frame 1500 from the GO e.g., the MAC address of the sensing responder.

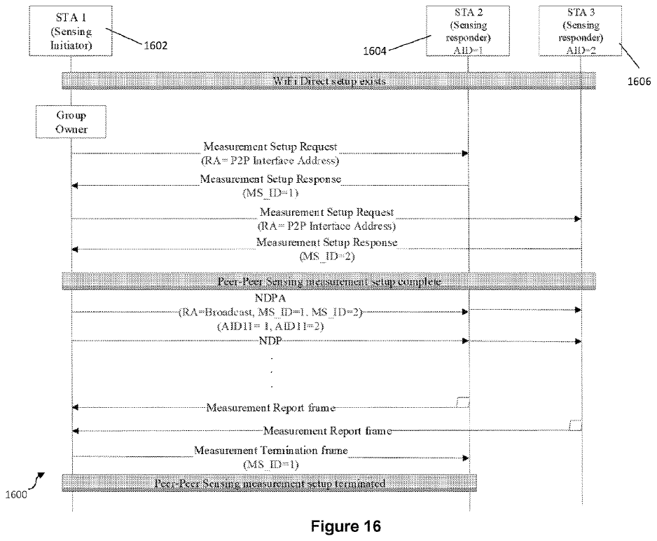

FIG. 16 depicts an illustration 1600 of a one-to-many sensing measurement process between a GO (e.g., STA1 1602) and two sensing responders (STA2 1604 and STA3 1606) according to an embodiment of the present disclosure. During sensing measurement setup, sensing measurement setup request frames transmitted from STA1 1602 to STA2 1604 and STA3 1606 indicate the respective P2P interface Address in a RA field (e.g., MAC address of STA2 1604 and STA3 1606 respectively), and sensing measurement setup response frames transmitted from each of STA2 1604 and STA3 1606 to STA1 1602 indicate the respective MS_ID (e.g., MS_ID=1 in the response frame from STA2 1604 and MS_ID=1 in the response frame from STA3 1606). MS_ID corresponds to measurement setup ID and it is tied to a respective sensing responder. STA1 1604 is assigned AID=1 and STA2 1606 is assigned AID=2 by the GO STA1 1602. During sensing measurement, a NDPA frame may be transmitted via a broadcast to both STA2 1604 and STA3 1606. The NDPA frame may indicate in the RA field that the NDPA frame transmission is a broadcast, and also indicate the MS_ID and AID11 values associated with both STA2 1604 and STA3 1606 (e.g., both MS_ID=1 and MS_ID=2, and both AID11=1 and AID11=2).

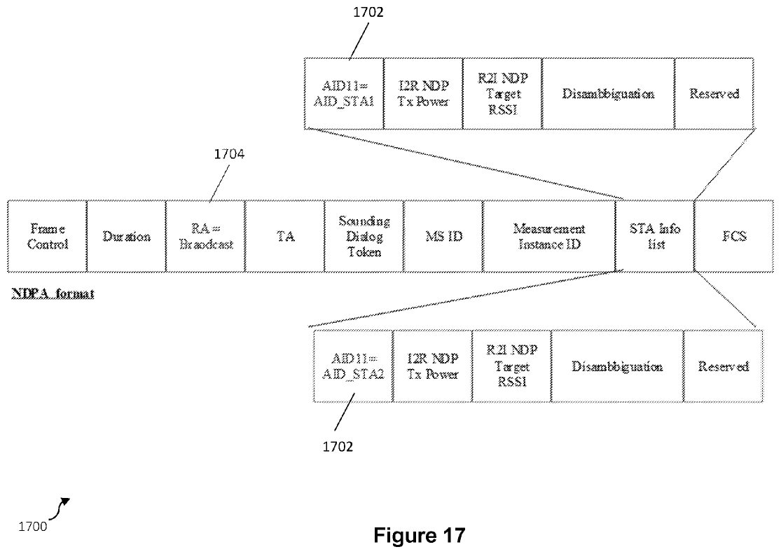

FIG. 17 depicts an illustration of a NDPA frame 1700 for a one-to-many sensing measurement case (e.g., as shown in illustration 1600 of FIG. 16) according to an embodiment of the present disclosure. The NDPA frame 1700 may comprise AID11 fields 1702 in which each AID11 field indicates an AID assigned by a GO to each respective sensing responder. It will be appreciated that there can be more than two AID11 fields if there are more than two sensing responders (e.g., an AID11 field for each respective sensing responder). The NDPA frame 1700 may also comprise a RA field 1704 to indicate that the NDPA frame is transmitted via broadcast to the sensing responder(s).

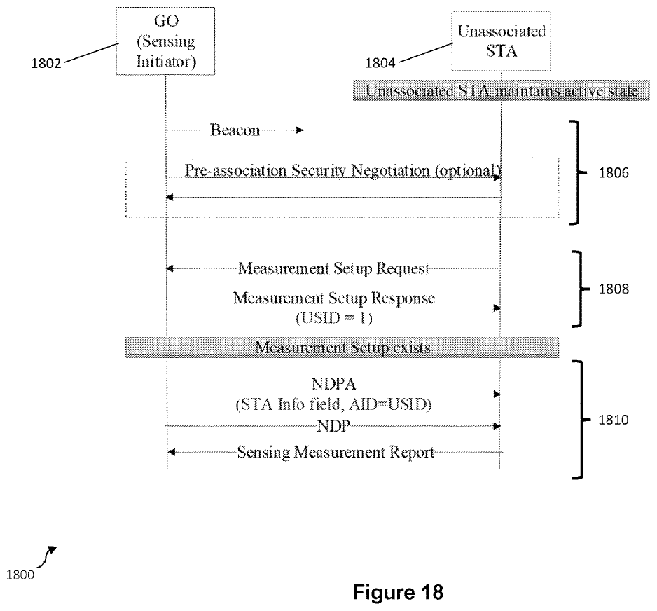

FIG. 18 depicts an illustration 1800 of a sensing measurement process between a GO 1802 and an unassociated STA 1804 according to various embodiments of the present disclosure.

In a discovery phase 1806, the GO 1802 transmits a beacon while unassociated STA 1804 maintains an active state to enable detection by the beacon. The beacon transmitted by the GO 1802 may carry a P2P Sensing Parameters element which indicates that the STA transmitting the beacon is a P2P sensing capable STA. The peer STA, STA 1804 receiving the beacon wait for the PASN exchange. An optional pre-association security negotiation (PASN) may be performed between the GO 1802 and unassociated STA 1804 for authentication purposes after discovery of the unassociated STA 1804. After discovery is completed, measurement setup request and response frames may be exchanged between the GO 1802 and unassociated STA 1804 in a measurement setup phase 1808, where the measurement setup response frame transmitted from the GO 1802 and unassociated STA 1804 indicates USID=1. The USID is assigned by the sensing initiator (e.g., GO 1802) to the unassociated STA 1804 to identify the unassociated STA and it has the same length as the AID. After the setup is completed, NDPA and NDP frames may be transmitted from the GO 1802 to unassociated STA 1804 in a sensing measurement phase 1810. The NDPA frame may comprise a STA Info field including an AID11 field that indicates the USID of the unassociated STA 1804. In response, the unassociated STA 1804 may transmit a sensing measurement report to the GO 1802.

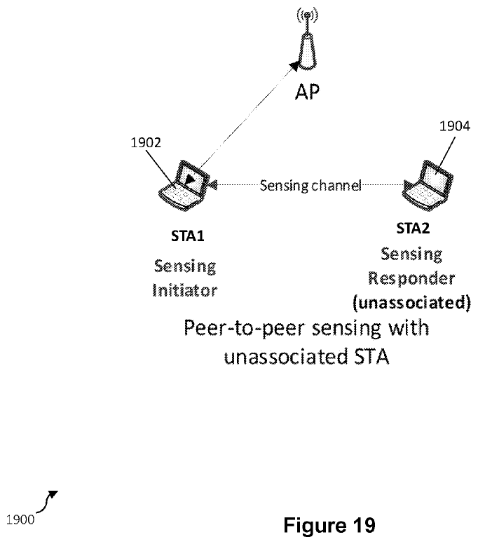

11bf currently only has a mechanism to support sensing between an unassociated STA (e.g., STA that is not connected with any AP) and an AP. In an embodiment, P2P sensing can also be performed between a non-AP STA and another unassociated non-AP STA without Wi-Fi Direct setup e.g., between non-AP STA 1902 and unassociated non-AP STA 1904 in illustration 1900 of FIG. 19. In order to enable P2P sensing with unassociated STAs, discovery of an unassociated STA by a non-AP sensing initiator must be made possible, and there should be an UID assignment procedure as well as a method to perform P2P sensing with unassociated STA.

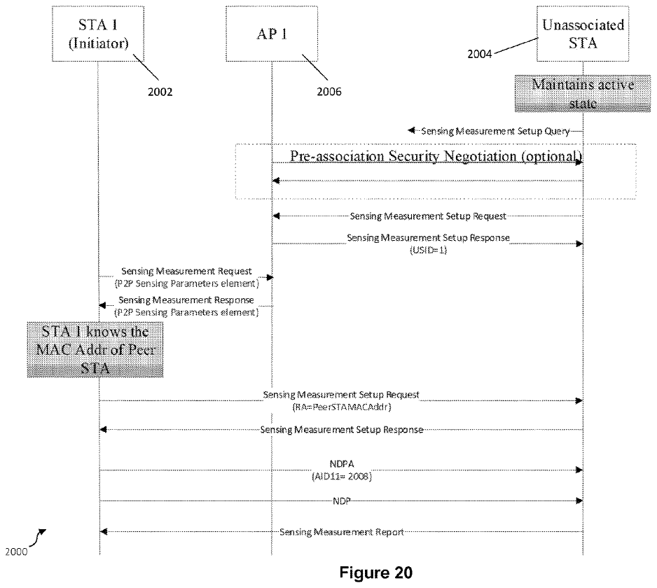

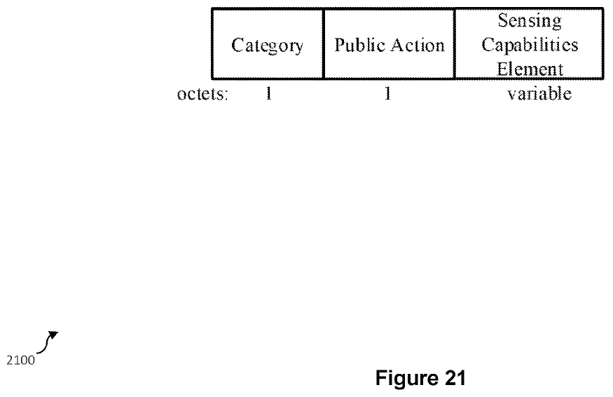

FIG. 20 depicts an illustration 2000 of an unassociated STA discovery and UID assignment process according to an embodiment of the present disclosure. Sensing setup is performed between AP1 2006 and unassociated STA 2004. For example, unassociated STA 2004 maintains an active state and sends a sensing measurement setup query to AP1 2006. The discovery or setup process may be called, alternatively, a registration process by an unassociated STA since the STA may register its information regarding sensing capability to an AP. The sensing measurement setup query is transmitted by the unassociated STA 2004 in active state to the AP1 2006 to announce its presence and capabilities, and may comprise an action field format as shown in sensing measurement setup query frame action field 2100 of FIG. 21. Alternatively or additionally, a Sensing Capabilities Element may be included in a Probe Request frame, and the frame may include an information, in the Sensing Capabilities Element or in the other element, to indicate the STA transmitting the frame is capable of P2P sensing outside the BSS (e.g. sensing in pre-association state or with an OBSS STA).

The AP 2006 upon receiving the sensing measurement setup query frame may optionally perform PASN negotiation to authenticate the unassociated STA 2004. After the negotiation is completed, the unassociated STA 2004 may transmit a sensing measurement setup request to the AP1 2006 to assign a USID (e.g., USID=1) to the unassociated STA 2004, which then responds with a sensing measurement setup response indicating USID=1. After the setup is complete, sensing initiator STA1 2002 can send a sensing measurement request with a P2P sensing parameters element (e.g., P2P sensing parameters element 1300 of FIG. 13) to the AP1 2006. STA1 2002 may send Sensing Measurement Request frames to obtain information about unassociated STA(s) from an AP before and/or after unassociated STA (e.g. STA 2004) completed the setup with the AP. In other words, STA1 2002 may conduct poll to AP1 2006 to obtain information about unassociated STA(s) that is capable of peer-to-peer sensing. Alternatively or additionally, AP1 2006 may inform of newly registered STA that is capable of peer-to-peer sensing (e.g. unassociated STA 2004) to non-AP STA(s) within the BSS. The non-AP STA (e.g. STA1 2002) may transmit a Sensing Measurement Request frame to obtain detailed information about the registered unassociated STA(s) such as MAC address and/or capability regarding sensing function, The sensing initiator STA1 2002 which indicate its capability to perform P2P sensing by transmitting the P2P Sensing parameters element may be informed of the capabilities and parameters of the unassociated STA 2004 by the AP1 2006, if the unassociated STA 2004 is also a P2P sensing capable STA. The AP1 2006 may respond by transmitting a sensing measurement response frame that also includes a P2P sensing parameters element. Based on the parameters received in the P2P sensing measurement parameters element, the sensing initiator STA1 2002 shall perform sensing measurement setup with the unassociated STA 2004.

Thereafter, upon receiving the P2P sensing parameters in the P2P Sensing Parameters element, STA1 2002 is aware of the USID, MAC address and other sensing related parameters as specified in P2P Sensing Parameters element of the unassociated STA 2004. The sensing initiator STA1 2002 may initiate the sensing measurement setup procedure between itself and the unassociated STA using the details of the unassociated STA 2004. Additionally, during the sensing measurement setup phase, sensing initiator may assign a separate special AID (for example, AID=2008) to the unassociated STA which overwrites the USID assigned by the AP 2006 and the initiator uses the assigned AID to set the AID11 of the NDPA.

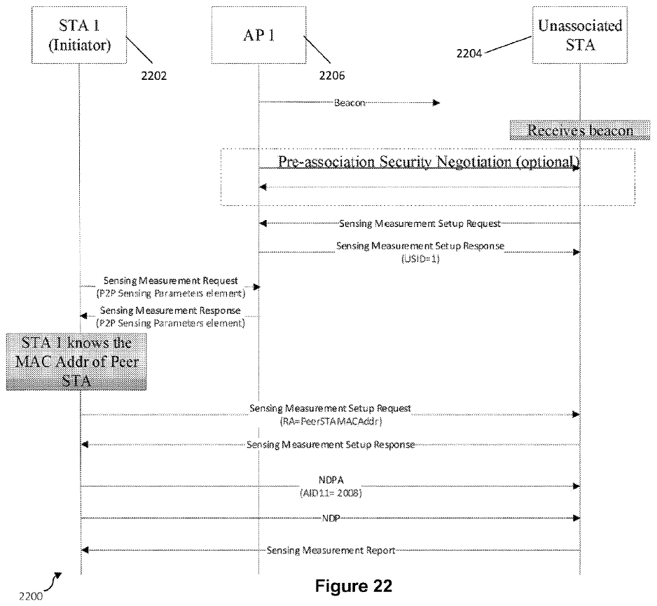

FIG. 22 depicts an illustration 2200 of a variation of the unassociated STA discovery and UID assignment process according to an embodiment of the present disclosure. While generally the same as the process shown in illustration 2000, the unassociated STA discovery process is different in that AP1 2206 transmits a beacon to do so, the unassociated STA 2204 upon receiving the beacon may wait for the PASN exchange and unassociated STA 2204 receives the beacon during an active state so that an optional PASN negotiation and/or sensing measurement setup can be performed between AP1 2206 and unassociated STA 2204 thereafter.

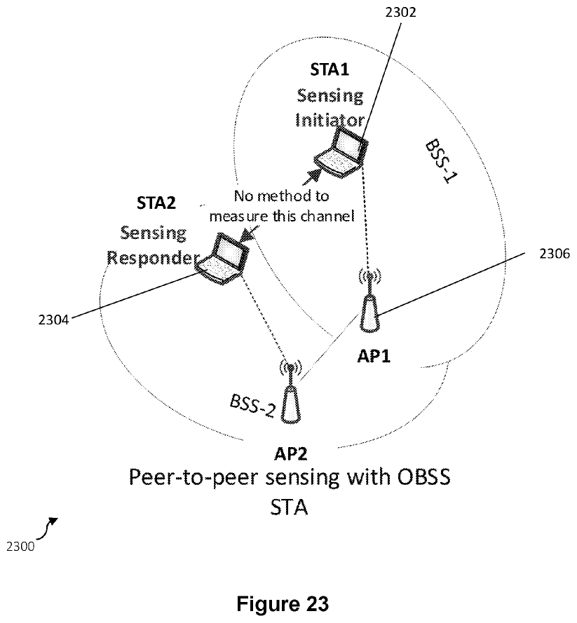

In an embodiment, peer-to-peer sensing may also be performed between STAs in OBSS which are close to each other e.g., between STA1 2302 and STA2 2304 in illustration 2300 of FIG. 23. In an example, STA1 2302 is associated with AP1 2306, and STA2 2304 is in the range of AP1 2306. To enable peer-to-peer sensing with a STA in OBSS, the key enablers are discovery of an OBSS STA capable of P2P sensing and the mechanism with which the two STAs can perform P2P sensing. For example, to perform P2P Sensing between STA1 2302 and STA2 2304 as shown in FIG. 23, STA1 2302 should know whether the STA2 2304 (e.g., an OBSS STA here in this example) has the capability of P2P Sensing, and how to perform P2P sensing with the STA2 2304 when STA2 2304 has such capability of P2P sensing.

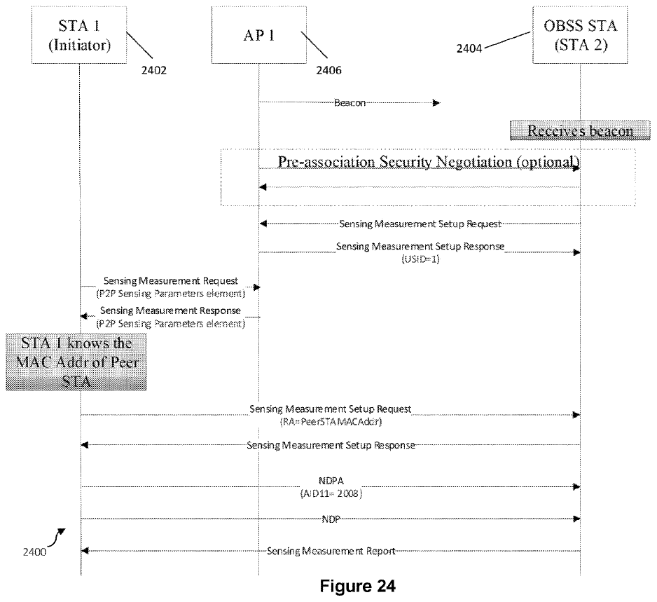

In the case of P2P sensing with an OBSS STA, the AP associated with the sensing initiator may treat the OBSS STA as an unassociated STA. FIG. 24 depicts an illustration 2400 of a peer-to-peer sensing measurement process between STA1 (sensing initiator) 2402 and STA2 (OBSS STA) 2404 according to an embodiment of the present disclosure. While generally the same as the process shown in illustration 2200, the difference is that, unlike unassociated STA 2204 which is not associated to any AP, the OBSS STA (STA2 2404) is associated to an AP2 (not shown) but it is treated as if it is an unassociated STA in a same BSS as STA1 2402.

During the sensing measurement setup between AP1 2406 and OBSS STA (STA2 2404), the USID assigned by AP1 may be coexisting with the AID of the OBBS STA (STA2 2404) which is assigned by the AP2 (not shown). Therefore, for the BSS in which the sensing initiator is present the OBSS STA is identified using the USID. The OBSS STA in its own BSS is identified by the AID assigned by the AP with which it is associated.

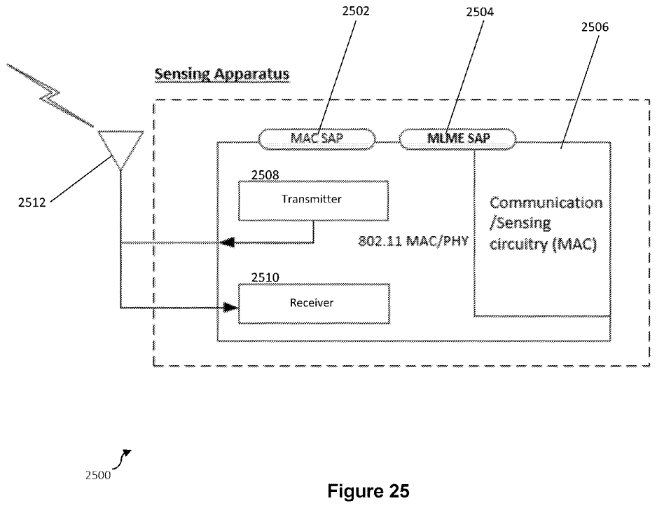

FIG. 25 depicts an example configuration of a STA suitable for sensing and communication in accordance with various embodiments of the present disclosure.

The communication apparatus 2500 is implemented as an AP or Non-AP STA for peer-to-peer sensing in accordance with various embodiments of the present disclosure. The communication apparatus 2500 comprises a MAC Service Access Point (MAC SAP) 2502 and a MAC sublayer Management Entity SAP (MLME SAP) 2504, and communication and sensing circuitry 2506. The communication apparatus also comprises a transmitter 2508, a receiver 2510 and an antenna 2512 used for transmitting/receiving signals to/from other communication apparatuses (e.g., STAs/APs) for peer-to-peer sensing.

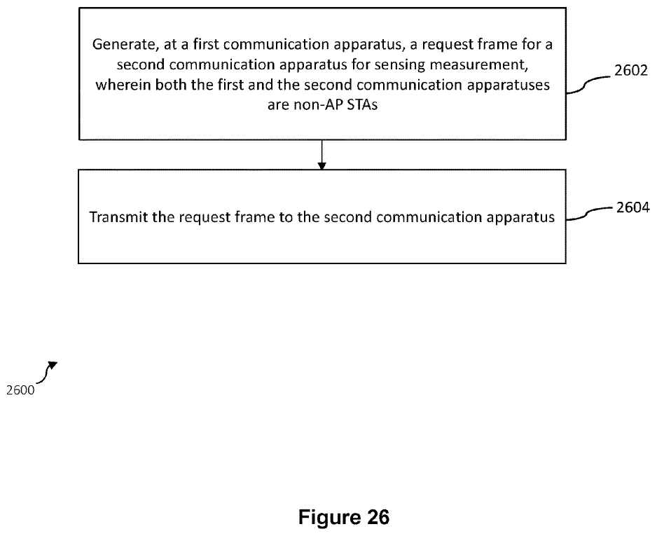

FIG. 26 shows a flow diagram 2600 illustrating a communication method according to various embodiments. At step 2602, a request frame may be generated, at a first communication apparatus, for a second communication apparatus for sensing measurement, wherein both the first and the second communication apparatuses are non-AP STAs. At step 2604, the request frame may be transmitted to the second communication apparatus. Further, the communication method may comprise transmitting a measurement request frame to the second communication apparatus with an assignment of AID for P2P sensing.

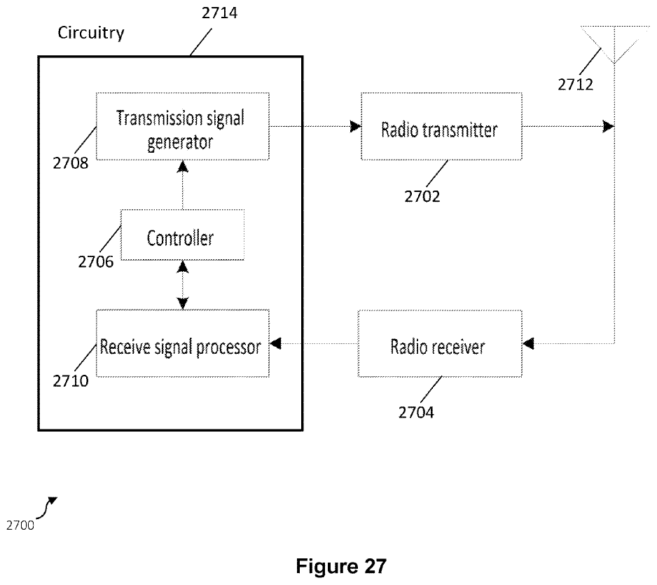

FIG. 27 shows a schematic, partially sectioned view of a communication apparatus 2700 that can be implemented for peer-to-peer sensing in accordance with the various embodiments. The communication apparatus 2700 may be implemented as an STA or AP according to various embodiments.

Various functions and operations of the communication apparatus 2700 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 27, the communication apparatus 2700 may include circuitry 2714, at least one radio transmitter 2702, at least one radio receiver 2704 and multiple antennas 2712 (for the sake of simplicity, only one antenna is depicted in FIG. 27 for illustration purposes). The circuitry may include at least one controller 2706 for use in software and hardware aided execution of tasks it is designed to perform, including control of communications with one or more other devices in a wireless network. The at least one controller 2706 may control at least one transmission signal generator 2708 for generating frames to be sent through the at least one radio transmitter 2702 to one or more other STAs or APs and at least one receive signal processor 2710 for processing frames received through the at least one radio receiver 2704 from the one or more other STAs or APs. The at least one transmission signal generator 2708 and the at least one receive signal processor 2710 may be stand-alone modules of the communication apparatus 2700 that communicate with the at least one controller 2706 for the above-mentioned functions. Alternatively, the at least one transmission signal generator 2708 and the at least one receive signal processor 2710 may be included in the at least one controller 2706. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 2702, at least one radio receiver 2704, and at least one antenna 2712 may be controlled by the at least one controller 2706. Furthermore, while only one radio transmitter 2702 is shown, it will be appreciated that there can be more than one of such transmitters.

In various embodiments, when in operation, the at least one radio receiver 2704, together with the at least one receive signal processor 2710, forms a receiver of the communication apparatus 2700. The receiver of the communication apparatus 2700, when in operation, provides functions required for processing an information container. While only one radio receiver 2704 is shown, it will be appreciated that there can be more than one of such receivers.

The communication apparatus 2700, when in operation, provides functions required for peer-to-peer sensing. For example, the communication apparatus 2700 may be a first communication apparatus, and the circuitry 2714 may, in operation, generate a request frame for a second communication apparatus for sensing measurement, wherein both the first and the second communication apparatuses are non-AP STAs. The transmitter 2702 may, in operation, transmit the request frame to the second communication apparatus.

The first communication apparatus may be configured to perform a setup procedure of a P2P group and becomes a Group Owner for performing sensing measurement within the P2P group. The first communication apparatus may be further configured to assign an association identifier (AID) to the second communication apparatus during the setup procedure of the P2P group, wherein the transmitter 2702 may be further configured to transmit an NDPA frame to the second communication apparatus, the NDPA frame including an AID field that contains at least part of bits of a value of the assigned AID.

The first communication apparatus may be associated with an AP, and the second communication apparatus may not be associated with the AP. The first communication apparatus may be further configured to assign an unassociated STA identifier (USID) to the second communication apparatus, wherein the first communication apparatus and the second communication apparatus do not belong to the same BSS. The first communication apparatus may be associated with an AP and further configured to request the AP to inform of an USID that is assigned by the AP to the second communication apparatus. The request frame may indicate the USID for sensing measurement with the second communication apparatus. The transmitter 2702 may be further configured to transmit an NDPA frame including the USID to the second communication apparatus.

The first communication apparatus may be further configured to perform a client discovery with an overlapping BSS (OBSS) AP prior to transmitting the request frame, wherein the client discovery is used for performing Tunneled Direct Link Setup (TDLS) with the second communication apparatus, wherein the second communication apparatus is within the OBSS. The transmitter 2702 may be further configured to transmit one or more frames carrying a P2P sensing capabilities element which when received by a communication apparatus initiate a sensing measurement setup procedure. The receiver 2704 may, in operation, receive a response frame from the second communication apparatus for performing P2P sensing measurement.

For example, the communication apparatus 2700 may be a second communication apparatus, and the receiver 2704 may, in operation, receive a request frame from a first communication apparatus, wherein both the first and the second communication apparatuses are non-AP STAs. The transmitter 2702 may, in operation, transmit a response frame to the first communication apparatus for performing P2P sensing measurement.

The second communication apparatus may either be in the BSS of the first communication apparatus or in the OBSS of the first communication apparatus. The second communication apparatus may be an associated or unassociated STA. The receiver 2704 may be further configured to receive an assignment of an AID when the second communication apparatus is an associated STA, or to receive an assignment of a USID when the second communication apparatus is an unassociated STA.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, an ultra-LSI, or a system on a chip (SoC) depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device, head mounted display (HMD), smart glasses), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

Thus, it can be seen that the present embodiments provide communication devices and methods for peer-to-peer sensing.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first communication apparatus comprising:
circuitry, which in operation, generates a request frame for a second communication apparatus for sensing measurement, wherein both the first and the second communication apparatuses are non-AP STAs; and
a transmitter, which in operation, transmits the request frame to the second communication apparatus.

2. The first communication apparatus of claim 1, wherein the first communication apparatus performs a setup procedure of a peer to peer (P2P) group and becomes a Group Owner for performing sensing measurement within the P2P group.

3. The first communication apparatus of claim 2, further configured to assign an association identifier (AID) to the second communication apparatus during the setup procedure of the P2P group, wherein the transmitter is further configured to transmit an NDPA frame to the second communication apparatus, the NDPA frame including an AID field that contains at least part of bits of a value of the assigned AID.

4. The first communication apparatus of claim 1, wherein the first communication apparatus is associated with an AP, and the second communication apparatus is not associated with the AP.

5. The first communication apparatus of claim 1, further configured to assign an unassociated STA identifier (USID) to the second communication apparatus, wherein the first communication apparatus and the second communication apparatus do not belong to the same BSS.

6. The first communication apparatus of claim 4 which is associated with an AP, further configured to request the AP to inform of an USID that is assigned by the AP to the second communication apparatus.

7. The first communication apparatus of claim 5, wherein the request frame indicates the USID for sensing measurement with the second communication apparatus.

8. The first communication apparatus of claim 7, wherein the transmitter is further configured to transmit an NDPA frame including the USID to the second communication apparatus.

9. The first communication apparatus of claim 1, further configured to perform a client discovery with an overlapping BSS (OBSS) AP prior to transmitting the request frame, wherein the client discovery is used for performing Tunneled Direct Link Setup (TDLS) with the second communication apparatus, wherein the second communication apparatus is within the OBSS.

10. The first communication apparatus of claim 9, wherein the transmitter is further configured to transmit one or more frames carrying a P2P sensing capabilities element which when received by a communication apparatus initiate a sensing measurement setup procedure.

11. The first communication apparatus of claim 1, further comprising a receiver, which in operation, receives a response frame from the second communication apparatus for performing Peer-to-Peer (P2P) sensing measurement.

12. A second communication apparatus comprising:
a receiver, which in operation, receives a request frame from a first communication apparatus, wherein both the first and the second communication apparatuses are non-AP STAs; and
a transmitter, which in operation, transmits a response frame to the first communication apparatus for performing P2P sensing measurement.

13. The second communication apparatus of claim 12, wherein the second communication apparatus is either in the BSS of the first communication apparatus or in the OBSS of the first communication apparatus.

14. The second communication apparatus of claim 12, wherein the second communication apparatus is an associated or unassociated STA.

15. The second communication apparatus of claim 12, wherein the receiver is further configured to receive an assignment of an AID when the second communication apparatus is an associated STA, or to receive an assignment of a USID when the second communication apparatus is an unassociated STA.

16. A communication method comprising:
generating, at a first communication apparatus, a request frame for a second communication apparatus for sensing measurement, wherein both the first and the second communication apparatuses are non-AP STAs;
and
transmitting the request frame to the second communication apparatus.

17. The communication method of claim 16, further comprising transmitting a measurement request frame to the second communication apparatus with an assignment of AID for P2P sensing.
